(19) United States
(12) Patent Application Publication
(10) Pub. No.: US 2021/0079913 A1
(43) Pub. Date: Mar. 18, 2021

(54) POSITIVE DISPLACEMENT PUMP INCLUDING A PLAIN BEARING FOR COMPONENTS EXPERIENCING AN OSCILLATING MOTION AT LOW SPEEDS

(71) Applicant: Cameron International Corporation, Houston, TX (US)

(72) Inventors: Jaakko Jalmari Halmari, Houston, TX (US); Jeffrey Pruitt, Humble, TX (US); Jonathan David Deagle, Vancouver (CA); Jens Onno Onneken, Merville (CA)

(21) Appl. No.: 16/569,757

(22) Filed: Sep. 13, 2019

(51) Int. Cl. F04B 53/18; F16C 17/02; F04B 19/04; F04B 15/00; E21B 21/01

(52) U.S. Cl. CPC F04B 53/18; F16C 17/02; F16C 2360/00; F04B 15/00; E21B 21/01; F04B 19/04

(57) ABSTRACT

A positive displacement pump of this disclosure includes a plain bearing comprising a composite material located between a first component that may experience an oscillating motion at low speed (or at low speed and high loads) and a second component located about the first. The pump may be a mud pump configured to circulate a drilling fluid into and out of a well bore during an oil/gas well drilling operation. The first component may be a wrist pin of a crosshead and the second component may be an end of a connecting rod. The composite material may be a bearing grade material that is self-lubricating and wet or contaminant tolerant or resistant. The composite material may include polyketone. In retrofit or new applications, the plain bearing may include a sleeve containing a liner made of the composite material. No external lubrication may be required, eliminating the need for lubricating structures.

### BACKGROUND

This section is intended to introduce the reader to various aspects of art that may be related to various aspects of the present disclosure, which are described or claimed below. This discussion is believed to be helpful in providing the reader with background information to facilitate a better understanding of the various aspects of the present disclosure. Accordingly, it should be understood that these statements are to be read in this light, and not as admissions of prior art.

This disclosure relates to bearing systems, apparatuses, and methods used in pumps operating at low speed and high loads. More particularly, the disclosure addresses bearings found in positive displacement pumps configured for high force/low speed applications such as but not limited to mud pumps that circulate a drilling fluid in connection with the drilling of oil and gas wells.

In the drilling of an oil or gas well, a drill bit is mounted on the end of an elongated rotating drill string which turns the bit and causes it to cut away the underlying earth and rock formations. During this operation a drilling fluid or mud is continuously pumped down through the drill string and into the region around the drill bit and then back up to the surface. This drilling mud is typically made up of clays, chemical additives and an oil or water base. The drilling mud cools and lubricates the drill bit, carries drill cuttings out from the well, and helps prevent pressurized fluids in the earth from blowing out through the drilled well. A mud pump operates at low speeds and high forces when circulating the mud under high pressure down the drill string and back up the annulus.

Referring to FIG. 1, a drilling fluid or mud circulation system 100 includes a mud pump 102 (or multiple mud pumps 102) that pumps the mud from the surface to a bottom hole assembly (“BHA”) 112 and back to the surface. Mud pumps are positive displacement pumps, which are able to pump at a constant flow rate at any pressure. Mud from the mud storage tank 104 is pumped through the pump 102, into a standpipe 108, and down the drill string 110 to the drill bit 114 at the bottom of the BHA 112. The mud leaves the drill string 110 through in the (hill bit 114, where it cook and lubricates the drill bit 114. The mud also carries the drill cuttings back to the surface as it flows up through the annulus 116. Once at the surface, the mud flows through a mud return line 118 that returns the mud to the mud storage tank 104.

Referring to FIG. 2, mud pumps like those typically found in drilling fluid or mud circulation systems have used roller bearing in all bearing locations, including but not limited to the wrist pin bearing. The wrist pin bearing allows for the angle to change between the connecting rod and crosshead connection while being loaded. Roller bearings generally prefer complete rotations, with all rollers passing through the loaded zone. Without the complete rotation of the bearing, only a few rollers are oscillating back and forth in the load zone. Since only a few rollers are loaded, they are worn faster than if the loading was shared among all rollers.

The roller bearings need to be lubricated. Because the wrist pin bearing moves during operation, routing of the lubrication oil to the bearing can be complicated. The wrist pin bearings are typically installed in a very shielded location, getting minimal oil splash. Some mud pump manufacturers have used fixed oil sprayers, directing oil to troughs mounted to the crossheads. Oil in the trough then gravity-feeds to the wrist pin bearing through holes drilled in the wrist pin. Other mud pump manufacturers have used different methods of directing the oil to the wrist pin bearing, but all involve multiple drilled holes that must line up properly.

Finding a replacement for the roller bearings could reduce the cost and complexity of the pump, as well as improve its operating life. Plain bearings, made from materials such as brass or bronze, have been used in positive displacement pumps, but almost all of these applications have been in higher speed machines or required separate lubrication. However, the low speeds and high forces in mud pumps have prevented plain bearings from being used.

### SUMMARY

This summary is provided to introduce a selection of concepts that are further described below in the detailed description. This summary is not intended to identify key or essential features of the claimed subject matter, nor is it intended to be used as an aid in determining or limiting the scope of the claimed subject matter as set forth in the claims.

In embodiments of this disclosure, a positive displacement pump includes a plain bearing comprising a composite material located between a first component that may experience an oscillating motion at low speed at low speed (or at low speed and high loads) and a second component located about the first. The pump may be a mud pump configured to circulate a drilling fluid into and out of a well bore during an oil/gas well drilling operation. The first component may be a wrist pin of a crosshead and the second component may be an end of a connecting rod. The composite material may be a bearing grade material that is self-lubricating and wet or contaminant tolerant or resistant. The composite material may include polyketone. No external lubrication may be required, eliminating the need for lubricating structures.

In some embodiments, the pump includes a plain bearing made of a sleeve containing a liner made of a composite material of this disclosure. The outer diameter of the liner may be an interference fit with the sleeve, an inner diameter of the liner being slideable on the oscillating component. In some embodiments, the sliding portion may be on the outer diameter of the bearing

The composite material may be a self-lubricating composite material. The composite material may be a water tolerant or contamination tolerant composite material.

The pump may be part of a system used to circulate a drilling fluid or mud into and out of a well bore during an oil/gas well drilling operation. The positive displacement pump may operate at speeds in a range of about 50 strokes per minute (“SPM”) to about 140 SPM, there being sub-ranges within this broader range. Loads can range from 0 lbf to about 230,000 lbf, there being subranges within this broader range. In some embodiments, the load may be a high load in a range about 100,000 lbf to about 230,000 lbf, there being subranges within this broader range.

### BRIEF DESCRIPTION OF THE DRAWINGS

The subject disclosure is further described in the following detailed description, and the accompanying drawing and schematic of non-limiting embodiment of the subject disclosure. The features depicted in the figure are not necessarily shown to scale. Certain features of the embodiments may be shown exaggerated in scale or in somewhat schematic form, and some details of elements may not be shown in the interest of clarity and conciseness.

FIG. 1 is a schematic illustrating a mud pump in relation to a drilling fluid or mud circulation system

FIG. 2 is a partial cross-section view of a prior art mud pump, illustrating a wrist pin roller bearing and its lubrication flow.

FIG. 3 is a partial cross-section view of a mud pump including an embodiment of a wrist pin plain bearing of this disclosure. The plain bearing includes a composite material and may be smaller in diameter than the prior art roller bearing. In retrofit applications, a sleeve or journal may be used to fill any space that results from the smaller diameter. In a new pump, the connecting rod size may be reduced, and the sleeve carrier size reduced or eliminated. Structures required for lubrication, such as piping, nozzles, a gravity-fed trough, and holes, see e.g. FIG. 2, may be eliminated.

FIG. 4A is an isometric view of an embodiment of a plain bearing of this disclosure including a sleeve with a bearing grade liner.

FIG. 4B is a cross-section view of the sleeve of FIG. 4A.

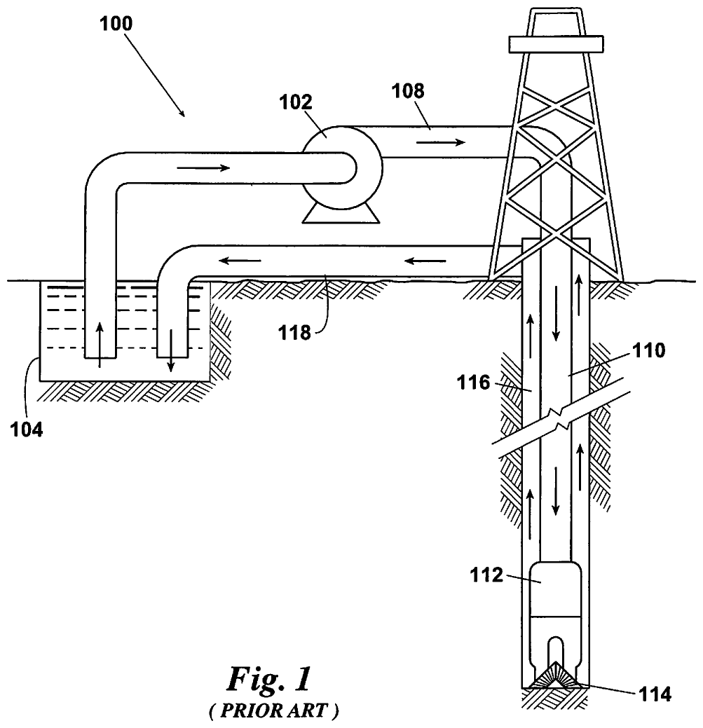

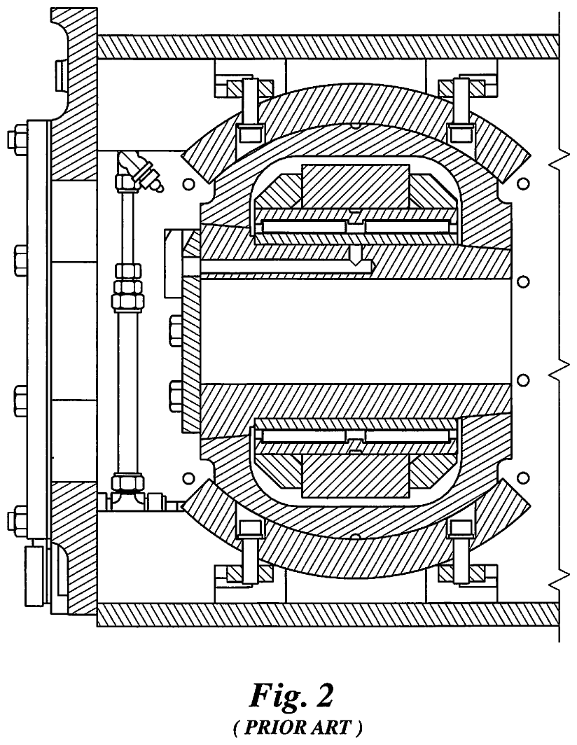

### DETAILED DESCRIPTION

Specific embodiments of the present disclosure will be described below. These described embodiments are only examples of the present disclosure. Additionally, in an effort to provide a concise description of these example embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

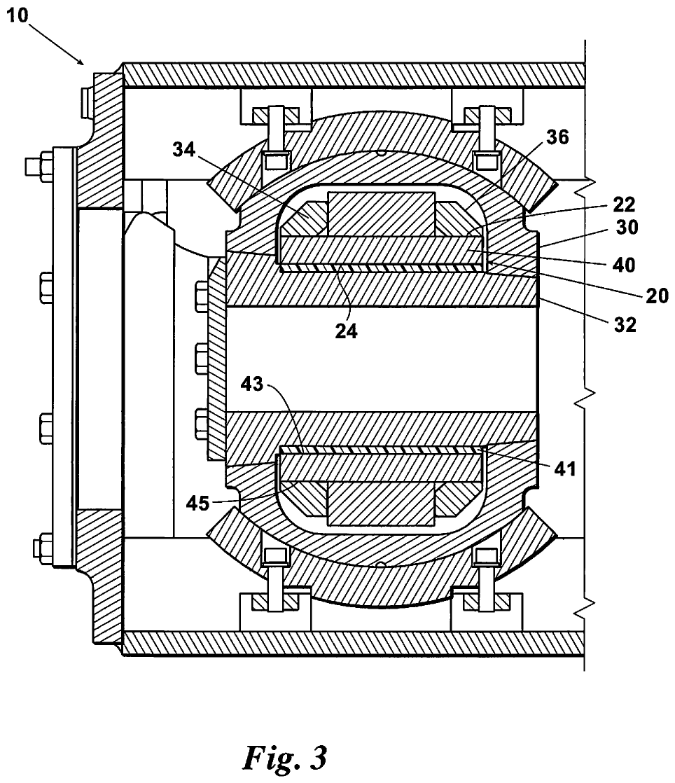

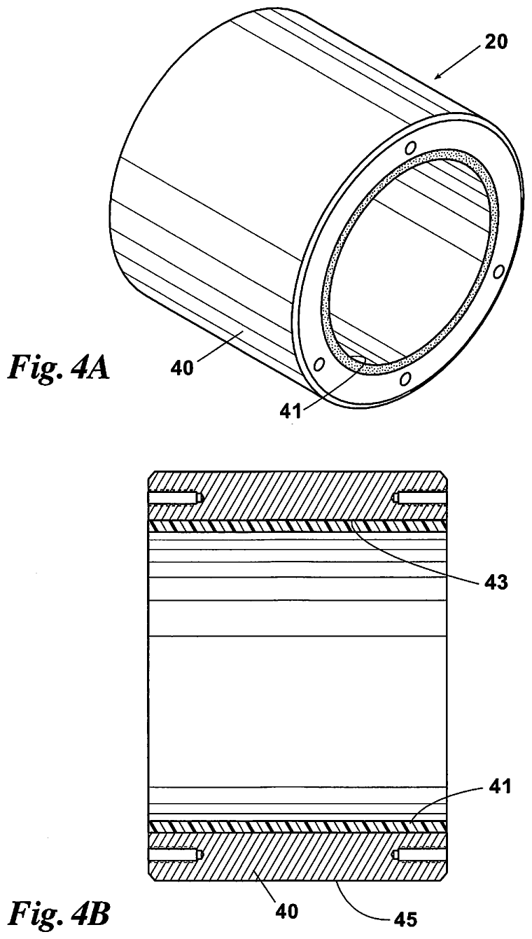

Referring to FIGS. 3 to 4B, embodiments of a positive displacement pump 10 of this disclosure include a composite material plain bearing 20 in place of a roller bearing where an oscillating motion may occur between mating components. The oscillating motion may occur at low speeds. For purposes of this disclosure, a plain bearing includes a bearing surface and no rolling elements. Low speed may be less than 500 fpm at the bearing pitch line. (At pump speeds in a range of about 50 SPM to about 140 SPM, mud pump main bearings and wrist pin bearings can fit in this range. (The relationship between fpm and SPM depends on bearing diameter and speed, with main, wrist pin, and eccentric bearings typically operating at the pump SPM and the pinion bearings operating about 4-5× faster.) Depending on size, eccentric and pinion bearings can be in a medium speed range above 500 fpm. High load can be in a range of about 100,000 lbf to about 230,000 lbf.

By way of a non-limiting, a plain bearing 20 of this disclosure may be installed in a 2,000 HP pump having a maximum speed of 140 SPM and a maximum load of about 141,000 lbf. In other embodiments, the plain bearing 20 may be installed in a pump 10 configured for operating speed in a range of 50 about SPM to about 140 SPM and loads in a range of about 100,000 lbf to about 230,000 lbf, there being speed and load subranges within these broader ranges.

In embodiments, the plain bearing 20 comprises a composite material suitable for transmitting high loads at low speeds. Suitable composite materials include, but are not limited to, bearing grade composite materials having self-lubricating properties, thereby reducing the need for external lubrication. In some embodiments, no external lubrication is required. The material may include a bearing-grade polyketone. The composite material and bearing may be metal-free Additionally, bearing grade materials such as polyketone are resistant or tolerant of contaminates such as but not limited to water, which corrodes traditional roller bearings and contamination particles, such as but not limited to drilling mud. Contamination can be brought into bearings by the lubrication. Therefore, although the materials may not require lubrication, lubrication oil can still be used with them. Bearings of this disclosure are tolerant to oils, therefore lubrication can be used with them. Also, splash lubrication does not need to be prevented from reaching the bearings.

In embodiments, the pump 10 may include a first component such as a crosshead 30 containing a wrist pin 32 that may experience an oscillating motion, with a second component such as one end 34 of a connecting rod 36 connected to the wrist pin 32. The composite material plain bearing 20 may be a wrist pin bearing located between the one end 34 and the wrist pin 32. The plain bearing 20 of this disclosure is best suited for the wrist pin bearing application but could be used in other locations as well.

Generally speaking, a wrist pin bearing is not an ideal application for a roller bearing because of the wrist pin's oscillating motion, placing the same few rollers loaded in the same location on the races. All other bearings in the pump experience full rotations, which is ideal for a roller bearing. The oscillating motion of the wrist pin can be ideal for the wrist pin as the speed is slow, allowing heat to transfer away from the bearing. Because the wrist pin oscillates, the pin typically stops twice every pump rotation, reducing the average speed. Rotating applications see a much higher average speed.

In some embodiments, the wrist pin 32 does not include a fluid passageway to provide lubrication to the bearing 20. Eliminating the oil lubrication and lubrication structures required by the prior art roller bearing reduces the complexity of the lubrication system of the pump 10 and may eliminate the need for it. Further, by eliminating lubrication of the bearing, contamination commonly found in a pump 20 is less likely to get into, or find its way to, the bearing 20.

The positive displacement pump 10 may be a mud pump like those used in oil-and-gas drilling operations. Unlike the prior art roller bearings—which have multiple components such as rings, rollers, and a roller retainer, and which contain all surfaces with relative motion—the plain bearing 20 can be made as a single piece. In other embodiments, the plain bearing 20 may be a two-piece assembly, each piece comprising one-half of the bearing. Other multiple piece arrangements may be used to construct the plain bearing 20. Regardless of its construction, the plain bearing 20 contains fewer different components than a roller bearing and includes no rolling elements. Additionally, the lubrication and associated piping, nozzles, trough, and holes may be eliminated or, in the case of a retrofit, not used or relied upon.

In some embodiments, composite material plain bearing 20 may be smaller in diameter than a roller bearing intended for use in a same application. For example, in a field retrofit of an existing pump 10, bearing 20 may include a spacer or sleeve 40 to fill in the space around the outside of the plain bearing 20, with the sleeve 40 being a same diameter as the roller bearing being replaced. The sleeve 40 may include a liner 41 made of a composite material of this disclosure to provide the bearing surface. By way of a non-limiting example, prior art roller bearings may have a 7.385″ ID and 10.5″ OD (about 1.55″ thick). A liner 41 in a retrofit application may be about 0.3″ thick (8″ OD, 7.385″ ID), while the sleeve 40 may have 10.5″ OD (to fit a prior art connecting rod) and 8″ ID (to match the liner).

The sleeve 40 may be a metal sleeve. The sleeve 40 may be a plastic sleeve pressed directly into the connecting rod 34. In some embodiments, the liner 41 is located on an inside diameter 43 of the sleeve 40. In other embodiments, the liner 41 may be located on an outside diameter 45 of the sleeve 40. For new production, the diameter of the one end 32 of the connecting rod 34 may be made smaller, thereby eliminating the need for a sleeve 40 and reducing the size of the connecting rod 34, crosshead 30, and crosshead guide.

The composite material plain bearing 20 may be sized to have an interference fit on its outside diameter 22, preventing motion, while the inside diameter 24 would slide on the mating component such as, but not limited to, a wrist pin 32. The surface roughness of the mating component may be appropriately smooth to improve reliability and extend the life of the plain bearing 20. For a field retrofit, a mating component with a smoother surface finish may be needed. By way of a non-limiting example, wrist pin surface smoothness may be in a range of about 8 RMS to about 16 RMS. While too rough a surface damages the bearing material, too smooth surface can also lead to shorter life. Because some bearing material may be transferred to the imperfections on the mating part, providing lubrication, with too smooth a surface there is no place for the material to go into. The final finish on the surface may be done by roller burnishing (as opposed to cutting, grinding and polishing) that pushes down any sharp high spots.

While the disclosure may be susceptible to various modifications and alternative forms, specific embodiments have been shown by way of example in the drawings and have been described in detail herein. However, it should be understood that the disclosure is not intended to be limited to the particular forms disclosed. Rather, the disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for” or “step for” performing a function, it is intended that such elements are to be interpreted under 35 U.S.C. 112(f). However, for any claims containing elements designated in any other manner, it is intended that such elements are not to be interpreted under 35 U.S.C. 112(f).

What is claimed:

1. A positive displacement pump comprising:
a crosshead containing a wrist pin;
a connecting rod having one end connected to the wrist pin; and
a plain bearing comprising a composite material located between and in contact with the one end of the connecting rod and the wrist pin.

2. The positive displacement pump of claim 1, wherein the composite material includes polyketone.

3. The positive displacement pump of claim 1, further comprising:
a sleeve containing the plain bearing;

4. The positive displacement pump of claim 3, wherein:
an outer diameter of the plain bearing comprises an interference fit with the sleeve, an inner diameter of the plain bearing being slideable on the wrist pin.

5. The positive displacement pump of claim 3, wherein:
an outer diameter of the plain bearing comprises a sliding portion.

6. The positive displacement pump of claim 1, wherein the composite material is self-lubricating composite material.

7. The positive displacement pump of claim 1, wherein the composite material is water tolerant composite material.

8. The positive displacement pump of claim 1, wherein the composite material is a contamination tolerant composite material.

9. The positive displacement pump of claim 1, wherein the positive displacement pump is configured to circulate a drilling mud into and out of a well bore during an oil/gas well drilling operation.

10. A drilling fluid circulation system comprising:
a positive displacement pump connected to a source of drilling fluid, the positive displacement pump including:
a crosshead containing a wrist pin;
a connecting rod having one end connected to the wrist pin; and
a plain bearing comprising a composite material located between and in contact with the one end and the wrist pin.

11. The drilling fluid circulation system of claim 10, wherein the composite material includes polyketone.

12. The drilling fluid circulation system of claim 10, further comprising:
a sleeve containing the plain bearing.

13. The drilling fluid circulation system of claim 12, wherein an outer diameter of the plain bearing comprises an interference fit with the sleeve, an inner diameter of the plain bearing being slideable on the wrist pin.

14. The drilling fluid circulation system of claim 12, wherein an outer diameter of the plain bearing comprises a sliding portion.

15. The drilling fluid circulation system of claim 10, wherein the composite material is self-lubricating composite material.

16. The drilling fluid circulation system of claim 10, wherein the composite material is a water tolerant, contamination tolerant, or water and contamination tolerant composite material.

17. The drilling fluid circulation system of claim 10, wherein the positive displacement pump is configured to circulate the drilling fluid into and out of a well bore during an oil/gas well drilling operation.

18. A positive displacement pump comprising:
a first component including an oscillating motion when in an intended use of said pump;
a second component located about the first component; and
a plain bearing comprising a composite material located between and in contact with the first and second components.
wherein in the intended use the positive displacement pump operates at low speed and high load.

19. The positive displacement pump of claim 18, wherein:
the first component is a crosshead containing a wrist pin; and
the second component is a connecting rod having one end connected to the wrist pin; and

20. The positive displacement pump of claim 18, the composite material including polyketone.
